(19) United States
(12) Patent Application Publication
(10) Pub. No.: US 2015/0093624 A1
(43) Pub. Date: Apr. 2, 2015

(54) ELECTRODE COMPOSITIONS AND RELATED ENERGY STORAGE DEVICES

(71) Applicant: General Electric Company, Schenectady, NY (US)

(72) Inventors: David Charles Bogdan, JR., Charlton, NY (US); Michael Alan Vallance, Albany, NY (US); Richard Louis Hart, Broadalbin, NY (US)

(21) Appl. No.: 14/559,274

(22) Filed: Dec. 3, 2014

Related U.S. Application Data
(63) Continuation-in-part of application No. 13/034,184, filed on Feb. 24, 2011.

(51) Int. Cl. H01M 10/39; H01M 4/38; H01M 2/16

(52) U.S. Cl. CPC H01M 10/399; H01M 2/1646; H01M 4/38; H01M 4/387; H01M 2300/0054; H01M 2220/20
USPC 429/112; 429/199

(57) ABSTRACT

A positive electrode composition is provided. The positive electrode composition includes at least one electroactive metal, a first alkali metal halide, an electrolyte comprising a complex metal halide having a second alkali metal halide; and sodium iodide. The electroactive metal is selected from the group consisting of nickel, cobalt, iron, zinc, tin, vanadium, niobium, manganese and antimony; and the first alkali metal halide and the second alkali metal halide independently comprise a halide selected from chlorine, bromine, and fluorine. The composition includes sodium iodide present in an amount in a range from about 0.1 weight percent to about 0.9 weight percent, based on a total weight of metal halides in the positive electrode composition. Related devices also form embodiments of this invention.

### CROSS REFERENCE TO RELATED APPLICATIONS

This application is a continuation-in-part of U.S. patent application Ser. No. 13/034,184 entitled “COMPOSITION, ENERGY STORAGE DEVICE AND RELATED PROCESSES” filed on Feb. 24, 2011, which is herein incorporated by reference.

### BACKGROUND

The invention includes embodiments that relate to electrode compositions, more specifically compositions for use in a positive electrode of an energy storage device. The invention also includes embodiments that relate to an energy storage device that utilize such electrode compositions.

Metal chloride batteries, especially sodium-nickel chloride batteries with a molten sodium anode and a beta-alumina solid electrolyte, are widely employed for energy storage applications. When the metal chloride batteries are employed in mobile applications like hybrid locomotives or plug-in electric vehicles (PHEV), the batteries should be capable of providing power surges (high currents) during discharging of the battery. This should be achieved without a significant loss in the working capacity and the cycle life of the battery. To provide better fuel economy via a regenerative battery braking (a power generation system, e.g., in PHEV's), an improved electric efficiency is desirable, since the ratio of a discharged energy to a charged energy decreases with an increase in the current. Attempts have been made to provide positive electrode compositions that can tolerate power surges. Modifying the positive electrode composition may provide one such solution, since an improved composition may significantly improve the cell working capacity, and decrease the capacity degradation rate.

There continues to be a growing need for additional improvements in the performance and the cycle life of the batteries. It may be desirable to have an electrode material that maintains or improves the performance of a sodium-metal chloride battery.

### BRIEF DESCRIPTION

In accordance with one aspect of the present invention, a positive electrode composition is provided. The positive electrode composition includes an electroactive metal, a first alkali metal halide, sodium iodide and an electrolyte that comprises a complex metal halide including a second alkali metal halide. The sodium iodide is present in an amount in a range from about 0.1 weight percent to about 0.9 weight percent, based on a total weight of metal halides present in the positive electrode composition. The electroactive metal is selected from the group consisting of nickel, cobalt, iron, zinc, tin, vanadium, niobium, manganese and antimony. The first alkali metal halide and the second alkali metal halide independently comprise a halide selected from chlorine, bromine, and fluorine.

Another embodiment is directed to an energy storage device. The device includes a first compartment including an alkali metal, a second compartment including a positive electrode composition, and a solid separator capable of transporting alkali metal ions between the first compartment and the second compartment. The positive electrode composition includes an electroactive metal, a first alkali metal halide, sodium iodide and an electrolyte that comprises a complex metal halide including a second alkali metal halide. The sodium iodide is present in an amount in a range from about 0.1 weight percent to about 0.9 weight percent, based on a total weight of metal halides present in the positive electrode composition. The electroactive metal is selected from the group consisting of nickel, cobalt, iron, zinc, tin, vanadium, niobium, manganese and antimony; and the first alkali metal halide and the second alkali metal halide independently comprise a halide selected from chlorine, bromine, and fluorine. An energy storage system including a plurality of the energy storage devices is also provided, in one embodiment.

### BRIEF DESCRIPTION OF THE FIGURES

These and other features, aspects, and advantages of the present invention will become better understood when the following detailed description is read with reference to the accompanying drawings, wherein:

FIG. 1 is a schematic view illustrating a front cross-sectional view of an electrochemical cell, in accordance with one embodiment of the invention;

FIG. 2 shows comparative results of discharge time during the charging cycle for comparative examples and examples in accordance with some embodiments described herein.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function. These terms may also qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances the event or capacity cannot occur—this distinction is captured by the terms “may” and “may be”.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

“Optional” or “optionally” means that the subsequently described event or circumstance may or may not occur, and that the description includes instances where the event occurs and instances where it does not.

Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

When introducing elements of various embodiments of the present invention, the articles “a,” “an,” “the,” and “said” are intended to mean that there are one or more of the elements. The terms “comprising,” “including,” and “having” are intended to be inclusive, and mean that there may be additional elements other than the listed elements. Furthermore, the terms “first,” “second,” and the like, herein do not denote any order, quantity, or importance, but rather are used to distinguish one element from another.

As described below, embodiments of the invention provide a positive electrode composition for use in a metal halide battery, for example a sodium-nickel chloride battery. The positive electrode composition includes an electroactive metal, a first alkali metal halide, sodium iodide, and an electrolyte that comprises a complex metal halide including a second alkali metal halide. The first alkali metal halide and the second alkali metal halide independently comprise a halide selected from chloride, bromide and fluoride. Sodium iodide is present in small amounts, specifically in a range from about 0.1 weight percent to about 0.9 weight percent, based on a total weight of metal halides present in the positive electrode composition. The positive electrode composition may also include products of the chemical or electrochemical interaction of the various elements listed herein. Advantageously, the invention solves or minimizes problems associated with a high current cell performance, by way of providing an improved positive electrode composition.

The positive electrode composition may help in increasing the maximum discharge power density of high-temperature sodium metal-halide cells. This may also increase the amount of time that these cells can sustain high-power discharging. Embodiments of the invention also provide an energy storage device comprising the positive electrode composition described herein. More particularly, the energy storage device includes an uninterruptible power supply (UPS) device, which is a device that is designed to deliver high power for short duration. Typically, the UPS device is designed to deliver high power for a period of about 1 second to about 2 hours, at average rates of about 0.5 D to about 10 D (wherein fD is a rate corresponding to full discharge of the energy storage battery in 1/f hour). Additionally, the increased power density may help in reducing the number of cells or devices per energy storage system e.g. a battery module, which may directly lead to a reduction in the cost of the system or the battery. Further, increasing the useful life of the energy storage system may lower the cost per product per year installed.

As used herein, “positive electrode composition” (or “cathode material”, “cathode composition”, “positive electrode material” or “cathodic material), which may all be used interchangeably) is the material that supplies electrons during charge and is present as part of a redox process. “Negative electrode composition” (or “anode material”, “anodic material” or “negative electrode material”) accepts electrons during charge and is present as part of the redox process.

An electrolyte is a medium that provides the ion transport mechanism between the positive and the negative electrodes of a device/cell, and may act as a solvent for the oxidized form of the positive electrode material. Additives that facilitate a primary redox process, but do not themselves provide the primary redox process, are distinguished from the electrolyte itself.

As noted, in one aspect of the present invention, a positive electrode composition is provided that includes at least one electroactive metal, a first alkali metal halide, sodium iodide and an electrolyte comprising a complex metal halide that includes a second alkali metal halide. The first alkali metal halide and the second alkali metal halide independently include a halide selected from chlorine, bromine, and fluorine. The sodium iodide is present in an amount in a range from about 0.1 weight percent to about 0.9 weight percent, based on a total weight of metal halides present in the positive electrode composition.

The electroactive metal, as used herein, is a metal that oxidizes in molten sodium tetrachloroaluminate, resulting in a metal halide salt above the oxidation potential of aluminum (about 1.58 V vs. Na/Na ion), and below the oxidation potential of chloride (about 4.15 V vs. Na/Na ion). In one embodiment, the electroactive metal may be at least one transition metal selected from the group consisting of nickel, cobalt, iron, zinc, tin, vanadium, niobium, manganese and antimony. Combinations of any of these metals are also possible. In some specific embodiments, the electroactive metal may be nickel. Nickel usually serves as the electronic conduction grid (i.e., a conductive structure or network) in the electrode. In some embodiments, the positive electrode composition includes at least two electroactive metals. For example, the composition may include nickel and iron.

Generally, the electroactive metal is present in an elemental form during the preparation or the construction of a positive electrode. In some embodiments, the electroactive metal may optionally include a salt form of the electroactive metal. In one embodiment, the electroactive metal salt may be in the form of a nitrate, sulfide, or halide of the electroactive metal. The halide salts are preferred in some instances.

In one embodiment, the amount of electroactive metal present in the positive electrode composition is in a range from about 10 volume percent to about 20 volume percent, based on a total volume of the positive electrode composition. In another embodiment, the amount of electroactive metal present is in a range from about 11 volume percent to about 19 volume percent. In yet another embodiment, the amount of electroactive metal present is in a range from about 12 volume percent to about 18 volume percent. One skilled in the art will appreciate that the electroactive metal, for example, nickel, is the positive electrode grid. In one embodiment, if the amount of nickel is not sufficient to percolate electronic current, the cell may not function as expected. In another embodiment, if the amount of nickel is in excess, it is at the expense of an electrolyte and/or alkali metal halide, both of which perform critical functions.

The first alkali metal halide is typically present in the positive electrode composition to promote the desired electrochemical reaction for an electrochemical cell or an energy storage device of interest. The first alkali metal halide may include a halide selected from chloride, bromide and fluoride. In some embodiments, the halides of sodium, potassium, or lithium are used. In some specific embodiments, the composition includes sodium chloride.

In one embodiment, the amount of the first alkali metal halide present in the positive electrode composition is in a range from about 15 weight percent to about 50 weight percent, based on the weight of the positive electrode composition. In another embodiment, the amount of the first alkali metal halide present in the positive electrode composition is in a range from about 20 weight percent to about 45 weight percent. In yet another embodiment, the amount of the first alkali metal halide present in the positive electrode composition is in a range from about 25 weight percent to about 40 weight percent.

The positive electrode composition may further include some additives that beneficially affect the performance of the energy storage device/cell. Such performance additives may increase the ionic conductivity, increase or decrease the solubility of the charged cathode species, improve the wetting of a solid separator by a molten electrolyte; or prevent the ripening of the positive electrode material. In some embodiments, an additive may be present in an amount less than about 5 weight percent (e.g., with a minimum level of about 0.1 weight percent), based on a total weight of the first alkali metal halide in the positive electrode composition. Examples of such additives include one or more additional metal halides, e.g., sodium fluoride and sodium bromide. In some embodiments, sodium fluoride is present at a level of about 0.1 weight percent to about 4 weight percent, based on the total weight of the first alkali metal halide present in the positive electrode composition.

Typically, the electroactive metal and the first alkali metal halide may be present in the form of granules in the positive electrode composition. In some embodiments, an amount of sodium iodide (as discussed in the above embodiments) is incorporated into the positive electrode composition during the step of the formation of the granules. As used herein, the term “granules” of the positive electrode composition includes most of the constituents of the positive electrode composition, except a molten electrolyte (discussed below). “Granules”, refers to particles of a variety of shapes, sizes and geometries. Granules may be in the state of coarse particles or a powder.

As noted, the positive electrode composition includes an electrolyte that is typically molten during use. As noted, the granules of the positive electrode composition are usually infused with the molten electrolyte (may also be referred to as electrolyte salt or molten-salt electrolyte). The electrolyte salt usually enables the transportation of the alkali ions from a solid separator (described later) to the positive electrode, and vice-versa. In one embodiment, the electrolyte salt includes a complex metal halide that is a reaction product of a second alkali metal halide and aluminum halide. In some embodiments, the electrolyte salt may include at least one additional metal halide, and forms a ternary or quaternary electrolyte. The electrolyte salt usually has a melting temperature of less than about 300 degrees Celsius. In one embodiment, the electrolyte salt has a melting temperature in a range from about 150 degrees Celsius to about 300 degrees Celsius, and in some specific embodiments, from about 150 degrees Celsius, to about 200 degrees Celsius. In one embodiment, the electrolyte salt has a melting temperature of about 185 degrees Celsius.

In one embodiment, the second alkali metal halide is at least one alkali metal halide selected from sodium chloride, sodium bromide, sodium fluoride, potassium chloride, potassium bromide, potassium fluoride, lithium chloride, lithium bromide, lithium fluoride, and cesium chloride. In one embodiment, the second alkali metal halide is sodium chloride. In one embodiment, the electrolyte salt includes a reaction product of sodium chloride and aluminum chloride.

In one embodiment, the second alkali metal halide and the aluminum halide of the electrolyte salt are present in a molar ratio in a range from about 0.5:0.5 to about 0.33:0.67 in the salt. In another embodiment, the second alkali metal halide and the aluminum halide are present in a molar ratio in a range from about 0.53:0.47 to about 0.45:0.55 in the salt. In yet another embodiment, when the second alkali metal halide is sodium chloride and the aluminum halide used is aluminum chloride, the ratio is typically about 0.51:0.49 to about 0.48:0.52, and the electrolyte salt is sodium tetrachloroaluminate (NaAlCl₄).

In one embodiment, the amount of electrolyte salt employed is in a range of about 22 weight percent to about 35 weight percent, based on the total weight of the positive electrode composition. In another embodiment, the amount of electrolyte salt employed is in a range of about 25 weight percent to about 32 weight percent, based on the total weight of the positive electrode composition. In yet another embodiment, the amount of electrolyte salt employed is in a range of about 28 weight percent to about 30 weight percent, based on the total weight of the positive electrode composition.

The positive electrode composition further includes sodium iodide. The presence of sodium iodide in the positive electrode composition provides significant advantages for electrochemical cells which incorporate such positive electrodes. (For example, please refer to U.S. Pat. No. 5,972,533, incorporated herein by reference, which describes in detail the working of an electrochemical cell). According to one embodiment of the invention, the amount of sodium iodide present in the positive electrode composition is in a range from about 0.1 weight percent to about 0.9 weight percent, based on a total weight of metal halides present in the positive electrode composition. The metal halides in the positive electrode composition often include the first alkali metal halide, and the complex metal halide (the second metal halide and aluminum halide) of the electrolyte. In some embodiments, the amount of sodium iodide is present in a range from about 0.2 weight percent to about 0.8 weight percent, and in some specific embodiments, from about 0.3 weight percent to about 0.7 weight percent, based on the total weight of metal halides present in the positive electrode composition.

In some embodiments, sodium iodide is present from about 0.1 weight percent to about 0.9 weight percent, based on a total weight of alkali metal halides present in the positive electrode composition. In some embodiments, the amount of sodium iodide is present in a range from about 0.2 weight percent to about 0.8 weight percent, based on the total weight of the alkali metal halides. The alkali metal halides generally include the first alkali metal halide, the second alkali metal halide and any additional alkali metal halide present in the electrode composition. As noted in other portions of this disclosure, the present inventors have discovered that the presence of sodium iodide at these reduced levels provides substantially similar results and improvements in the performance of the cell as provided by high amounts of sodium iodide. In other words, an additional/excess amount of sodium iodide (in addition to about 1 weight percent) provides no additional improvement in the performance of the cell.

Furthermore, there are additional benefits of using the low amounts of sodium iodide. The embodiments described herein allow for operation of a cell that utilizes the positive electrode i.e., cathode, more cost-effectively. Often, the cathode of a conventional cell contains a considerable amount (e.g., more than about 3 weight percent) of sodium iodide. When added, sodium iodide usually substitutes the first alkali metal halide e.g., sodium chloride. There are several disadvantages to the inclusion of sodium iodide in the cathode composition. Sodium iodide has a higher molar mass (g/mole) and higher molar volume (m³/mole) as compared to sodium chloride, and thus sodium iodide is a weight-ineffective and volume-ineffective source of sodium ions. In addition, sodium iodide is highly hydrophilic; and thus associated with an amount of moisture. The high level of moisture in the electrode composition may adversely affect the performance and safety of the cell. Moreover, sodium iodide is more expensive than sodium chloride, and thus cost-ineffective if used in high amounts. Thus, a reduced amount, as disclosed herein, of sodium iodide is economically desirable and beneficial to provide improved performance and design of the cell. An additional/excess amount of sodium iodide may enhance the complexity of the cell design (weight, volume and components), increase the cost of the cell, and provide no additional benefit.

In one embodiment, the positive electrode composition may further include aluminum, i.e., in a form other than an electrolyte salt or an aluminum halide. Usually, the aluminum would be in elemental form, e.g., aluminum metal flakes or particles. The aluminum may assist in improving the porosity of the granules formed using the electroactive metal, iron, and the first alkali metal halide, described in the Examples. In some embodiments, the amount of elemental aluminum present in the positive electrode composition may be in a range from about 0.1 weight percent to about 1.5 weight percent, based on the total weight of the positive electrode composition.

In one embodiment (though not all embodiments, as discussed below), the positive electrode composition may further comprise sulfur, in the form of molecular sulfur or a sulfur-containing compound. If present, the sulfur is usually present in an amount up to about 25 weight percent, based on the total weight of the positive electrode composition. In some embodiments, the sulfur is desirable in low amounts, depending on the end use applications, for example from about 0.1 weight percent to about 3 weight percent, based on the total weight of the positive electrode composition. In some other embodiments, a high amount of sulfur is desirable, for example in a range from about 10 weight percent, to about 25 weight percent. High amounts of sulfur in the positive electrode (U.S. Patent Publication. No. 20140178791A1) have shown an improvement in the charging rate and a reduction in the degradation rate, and thereby improvements in the performance of a battery, as compared to a battery having a small or negligible amount of sulfur in the positive electrode.

In yet other embodiments, the positive electrode composition is substantially free of sulfur, i.e., containing, at most, impurity levels. The absence of sulfur is desirable in some cases because sulfur may be corrosive to diffusion bonds between ceramics and metals, which are often used in the electrochemical cells. Also, sulfides have, in some cases, been known to reduce performance in UPS applications.

In accordance with one aspect of the present invention, an article is provided. The article includes a positive electrode composition, as described herein. As one example, the article may be in the form of an energy storage device. The device usually includes (a) a first compartment comprising an alkali metal; (b) a second compartment including a positive electrode composition, as described herein; and (c) a solid separator capable of transporting alkali metal ions between the first and the second compartments. The details of the positive electrode composition are described previously.

The device also includes a housing that usually has an interior surface defining a volume. A separator is disposed in the volume. The separator has a first surface that defines at least a portion of a first compartment, and a second surface that defines a second compartment. The first compartment is in ionic communication with the second compartment through the separator. As used herein, the phrase “ionic communication” refers to the traversal of ions between the first compartment and the second compartment, through the separator.

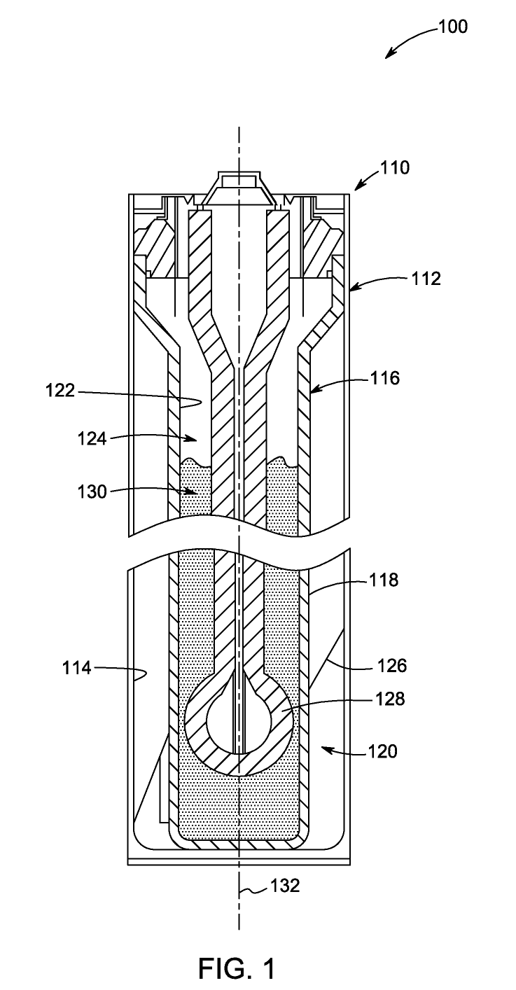

Referring to FIG. 1, an electrochemical cell 100 is provided. More particularly, a front cross-sectional view 110 of the cell is depicted. The electrochemical cell 100 includes a housing 112. The housing 112 usually has an interior surface 114, defining a volume. A separator 116 is disposed inside the housing 112. The separator 116 has a first surface 118 that defines a first compartment 120, i.e., an anode compartment. The separator has a second surface 122 that defines a positive electrode compartment 124. An anode current collector 126 is connected to the anode compartment 120. A positive electrode current collector 128 is connected to the positive electrode compartment 124. A positive electrode composition 130 is disposed inside the positive electrode compartment 124. The positive electrode composition 130 mainly includes at least one electroactive metal, sodium iodide, a first alkali metal halide, and an electrolyte that comprises a complex metal halide salt including a second alkali metal halide. The first alkali metal halide and the second alkali metal halide may independently include a halide selected from chloride, bromide, and fluoride. Sodium iodide is usually present in an amount in a range from about 0.1 weight percent to about 0.9 weight percent, based on the total weight of metal halides in the positive electrode composition. The working temperature of the electrochemical cell 100, when it is a sodium-nickel chloride cell, is about 300 degrees Celsius.

The housing can be sized and shaped to have a cross-sectional profile that is square, polygonal, or circular, for example. Typically, the aspect ratio of the housing is determined by the aspect ratio of the separator. In many cases, the walls of the separator should be slender, to reduce the average ionic diffusion path length. In one embodiment, the height to effective diameter ratio (2×(square root of (cross-sectional area/pi)) of the housing is greater than 5 times, and in another embodiment it is greater than 7 times. The housing can be formed from a material that is a metal, ceramic, or a composite; or some combination thereof. The metal can be selected from nickel or steel, as examples; and the ceramic is often a metal oxide.

Typically, an anode compartment is empty in the ground state (uncharged state) of the electrochemical cell, and is filled with metal from reduced metal ions that move from the positive electrode compartment to the anode compartment through the separator, during operation of the cell. The anodic material, for example, sodium, is molten during use. The first compartment or the anode compartment 120 may receive and store a reservoir of anodic material, i.e., molten sodium.

Additives suitable for use in the anodic material may include a metal oxygen scavenger. Suitable metal oxygen scavengers may include one or more of manganese, vanadium, zirconium, aluminum, or titanium. Other useful additives may include materials that increase wetting of the separator surface 116 defining the anode compartment, by the molten anodic material. Additionally, some additives or coatings may enhance the contact or wetting between the separator and the current collector, to ensure substantially uniform current flow throughout the separator.

The separator is usually an alkali metal ion conductor solid electrolyte that conducts alkali metal ions during use between the first compartment and the second compartment. Suitable materials for the separators may include an alkali-metal-beta′-alumina, alkali-metal-beta″-alumina, alkali-metal-beta′-gallate, or alkali-metal-beta″-gallate. In various embodiments, the solid separator may include a beta-alumina, a beta″-alumina, a gamma alumina, or a micromolecular sieve such as, for example, a tectosilicate, such as a felspar, or a felspethoid. Other exemplary separator materials include zeolites, for example a synthetic zeolite such as zeolite 3A, 4A, 13X, ZSM-5; rare-earth silicophosphates; silicon nitride; or a silicophosphate; a beta′-alumina; a beta″-alumina; a gamma alumina; a micromolecular sieve; or a silicophosphate (NASICON: Na₃Zr₂Si₂PO₁₂). In some preferred embodiments, the separator includes a beta alumina. In one embodiment, a portion of the separator is alpha alumina, and another portion of the separator is beta alumina. The alpha alumina may be relatively more amenable to bonding (e.g., compression bonding) than beta alumina, and may help with sealing and/or fabrication of the energy storage device.

The separator 116 can be sized and shaped to have a cross-sectional profile that is square, polygonal, circular, or clover leaf, to provide a maximum surface area for alkali metal ion transport; and can have a width to length ratio that is greater than about 1:10, along a vertical axis 132. In one embodiment, the length to width ratio of the separator 116 is in a range of from about 1:10 to about 1:5, from about 1:5 to about 1:1, from about 1:1 to about 5:1, from about 5:1 to about 10:1, or from about 10:1 to about 15:1. The ionic material transported across the separator 116 between the anode compartment 120 and the positive electrode compartment 124 can be an alkali metal. Suitable ionic materials may include cationic forms of one or more of sodium, lithium and potassium.

The separator may be stabilized by the addition of small amounts of a dopant. The dopant may include one or more oxides selected from lithia, magnesia, zinc oxide, and yttria. These stabilizers may be used alone or in combination with themselves, or with other materials. In one embodiment, the separator comprises a beta alumina separator electrolyte (BASE), and may include one or more dopants.

Referring to FIG. 1, the separator 116 is disposed within the volume of the housing 112. The separator may have a cross-sectional profile normal to a vertical axis 132 of the housing 112. Examples of profiles/shapes include a circle, a triangle, a square, a cross, a clover leaf, or a star. Alternatively, the cross-sectional profile of the separator can be planar about the vertical axis 132. A planar configuration (or one with a slight dome) may be useful in a prismatic or button-type battery configuration, where the separator is domed or dimpled. Similarly, the separator can be flat or undulated. In one embodiment, the solid separator may include a shape which may be flat, undulated, domed or dimpled, or comprises a shape with a cross-sectional profile that may be an ellipse, triangle, cross, star, circle, cloverleaf, rectangular, square, or multi-lobal. The separator can be a tubular container in one embodiment, having at least one wall. The wall can have a selected thickness; and an ionic conductivity. The resistance across the wall may depend in part on that thickness. In some cases, the thickness of the wall can be less than about 5 millimeters. A cation facilitator material can be disposed on at least one surface of the separator, in one embodiment. The cation facilitator material may include, for example, selenium, as discussed in published U.S. Patent Publication No. 20100086834, incorporated herein by reference.

Optionally, one or more shim structures can be disposed within the volume of the housing. The shim structures support the separator within the volume of the housing. The shim structures can protect the separator from vibrations caused by the motion of the cell during use, and thus reduce or eliminate movement of the separator relative to the housing. In one embodiment, a shim structure functions as a current collector.

The energy storage device may have a plurality of current collectors, including anode current collectors and positive electrode current collectors. The anode current collector is in electrical communication with the anode chamber, and the positive electrode current collector is in electrical communication with the contents of the positive electrode chamber. Suitable materials for the anode current collector may include tungsten, titanium, nickel, copper, molybdenum, and combinations of two or more of the foregoing metals. Other suitable materials for the anode current collector may include carbon. The positive electrode current collector may be a wire, paddle or mesh formed from platinum, palladium, gold, nickel, copper, carbon, or titanium. The current collector may be plated or clad. In one embodiment, the current collector is free of iron.

The second compartment includes a positive electrode composition of the present invention. As noted above, the positive electrode composition comprises: at least one electroactive metal; sodium iodide; a first alkali metal halide, and an electrolyte. Details of the positive electrode composition are described previously.

The positive electrode composition may be self-supporting or may be liquid/molten, in some embodiments. In one embodiment, the positive electrode composition is disposed on an electronically conductive support structure. The support structure, itself may not undergo any chemical reaction during the charge/discharge, and may simply support the positive electrode material during the chemical reactions. The support structure may be present in a number of forms, such as a foam, a mesh, a weave, a felt, or a plurality of packed particles, fibers, or whiskers. In one embodiment, a suitable support structure may be formed from carbon or a metal.

In one embodiment, the alkali metal forming the first alkali metal halide may be sodium, and the separator may be beta-alumina. In another embodiment, the alkali metal forming the first alkali metal halide may be potassium or lithium, with the separator then being selected to be compatible therewith. For example, in embodiments where the ions include potassium cations, the separator material may include beta alumina. In certain other embodiments, where lithium cations are used, a lithiated borophosphate BPO₄—Li₂O, may be employed as the separator material.

A plurality of the electrochemical cells can be organized into an energy storage system. Multiple cells can be connected in series or parallel, or in a combination of series and parallel. For convenience, a group of coupled cells may be referred to as a module or pack. The ratings for the power and energy of the module may depend on such factors as the number of cells in the module. Other factors may be based on end-use application specific criteria.

In accordance with one aspect of the present invention, an uninterruptible power supply device is provided. The device includes a positive electrode composition, as described previously. The primary role of any UPS device is to provide short-term power when the input power source fails. However, most UPS units are also capable in varying degrees of correcting common utility power problems, such as for example: (i) Power failure: defined as a total loss of input voltage; (ii) Surge: defined as a momentary or sustained increase in the mains voltage (iii) Sag: defined as a momentary or sustained reduction in input voltage, (iv) Spikes, defined as a brief high voltage excursion, (v) Noise, defined as a high frequency transient or oscillation, usually injected into the line by nearby equipment, (vi) Frequency instability: defined as temporary changes in the mains frequency, and (vii) Harmonic distortion defined as a departure from the ideal sinusoidal waveform expected on the line.

The general categories of modern UPS systems are on-line, line-interactive, or standby. An on-line UPS uses a “double conversion” method of accepting AC input, rectifying to DC for passing through the rechargeable battery, then inverting back to 120V/230V AC for powering the protected equipment. A line-interactive UPS maintains the inverter in line and redirects the battery's DC current path from the normal charging mode to supplying current when power is lost. In a standby system, the load is powered directly by the input power; and the backup power circuitry is only invoked when the utility power fails.

In one embodiment, the energy storage device may be rechargeable over a plurality of charge-discharge cycles. In another embodiment, the energy storage device may be employed in a variety of applications; and the plurality of cycles for recharge is dependent on factors such as charge and discharge current, depth of discharge, cell voltage limits, and the like.

Various embodiments of the energy storage system can store an amount of energy that is in a range of from about 0.1 kiloWatt hours (kWh) to about 100 kWh. One embodiment of the energy storage system has an energy-by-weight ratio of greater than about 100 Watt-Hours per kilogram, and/or an energy-by-volume ratio of greater than about 200 Watt-Hours per liter. Another embodiment of the energy storage system has a specific power rating of greater than about 150 Watts per kilogram; and/or an energy-by-volume ratio of greater than about 300 Watt-Hours per liter.

Some of the suitable energy storage systems may have an application specific power to energy ratio of less than about 10 per hour to about 1 per hour. In one embodiment, the specific power to energy ratio is in a range from about 1:1 to about 2:1, from about 2:1 to about 4:1, from about 4:1 to about 6:1, from about 6:1 to about 8:1, or from about 8:1 to about 10:1. In other embodiments, the power to energy ratio is in range from about 1:1 to about 1:2, from about 1:2 to about 1:4, from about 1:4 to about 1:6, from about 1:6 to about 1:8, or from about 1:8 to about 1:10. In one embodiment, the range is from about 1:1 to 3:1.

In one embodiment, a heat management device maintains the temperature of the energy storage system. The heat management device can warm the energy storage system if too cold, and can cool the energy storage system if too hot, to prevent an accelerated cell degradation. The heat management system includes a thaw profile that can maintain a minimal heat level in the anode and positive electrode chambers, to avoid freezing of cell reagents.

Another embodiment of the invention provides an energy management system that includes a second energy storage device that differs from the first energy storage device. This dual energy storage device system can address the ratio of power to energy, in that a first energy storage device can be optimized for efficient energy storage, and the second energy storage device can be optimized for power delivery. The control system can draw from either energy storage device as needed, and charge back either energy storage device that needs such a charge.

Suitable second energy storage devices, for the power piece, include a primary battery, a secondary battery, a fuel cell, or an ultracapacitor. A suitable secondary battery may be a lithium battery, lithium ion battery, lithium polymer battery, or a nickel metal hydride battery.

### Examples

The following examples illustrate methods and embodiments in accordance with the invention, and as such should not be construed as imposing limitations upon the claims. Unless specified otherwise, all of the components are commercially available from common chemical suppliers as indicated in Table 1 below.

TABLE 1

| Material | Source | Properties |
|---|---|---|
| Nickel 255 (metal | Inco Special | 97.9 percent pure, 0.6 square |
| nickel powder, Ni) | products | meters per gram surface area, |
| | | 2.2 to 2.8 micrometers particle |
| | | size) |
| Sodium Chloride | Custom Powders | 99.99 percent pure |
| (NaCl) | Ltd, UK | |
| Iron (metal iron | Alfa Aesar Item | less than 10 micrometers particle |
| powder) (Fe) | #00170, | size, 99.9 percent pure |
| Aluminum powder | Alfa Aesar Item | −100 + 325 mesh particle |
| (Al) | #42919 | size, 99.97 percent pure |
| Sodium Fluoride | Sigma Aldrich | ~99 percent pure |
| (NaF) | | |
| Sodium iodide (NaI) | Sigma Aldrich | ~99 percent pure |

The sodium chloride (NaCl) was heat treated at 220 degrees Celsius under vacuum, and milled to an average particle size of 90 percent less than 75 micrometers in a laboratory mill, in a dry glove box. Positive electrode materials including metal nickel powder, sodium chloride, sodium fluoride, sodium iodide, and iron, and aluminum powder were pressed at ambient room temperature (typically 18 degree Celsius to about 25 degree Celsius), under a linear pressure of about 110 bar to about 115 bar, using an Alexanderwerk WP50N/75 Roll Compactor/Milling Machine. The pressurized material was ground under a rotating mill into granules; and the fraction containing a particle size of about 0.325 to about 1.5 millimeters was used for the cell assembly.

### Preparation of Electrolyte Salt: Sodium Tetrachloroaluminate

Sodium chloride and aluminum chloride were mixed and melted together to produce sodium tetrachloroaluminate (NaAlCl₄). Aluminum chloride was volatile when melted, so mixing and melting of the electrolyte salt was done as a separate step, before electrochemical cell fabrication.

Preparation of the electrolyte salt was carried out in a nitrogen purge box, to keep the materials dry. To produce a 750 gram batch of NaCl-rich (basic) sodium tetrachloroaluminate, 500 grams of aluminum chloride and 250 grams of sodium chloride were mixed in a 500-milliliter reaction vessel. The reaction vessel was sealed with a clamped lid equipped with a gas outlet that was connected to a mineral oil bubbler to relieve any pressure.

The reaction vessel containing the dry powders was heated to 330 degrees Celsius, which was above the melting point of the electrolyte salt mixture. Once melted, about 5 grams to 10 grams of aluminum powder was introduced to the molten salt. The aluminum powder, which oxidizes readily, acts to scavenge impurities present in the raw materials.

Once melted, with impurities precipitated out, the sodium tetrachloroaluminate was filtered to remove the aluminum powder and the precipitates. The molten salt was filtered through a heated (from about 200 to about 300 degrees Celsius) glass frit (25 micrometers minimum pore size). The filtered molten salt was collected on aluminum foil. Once the filtered molten salt had solidified, it was manually chipped into smaller pieces, and then milled in a dedicated, laboratory-scale, grinding mill for 60 seconds. The sodium tetrachloroaluminate powder was stored in a glove box for use in cell fabrication as an electrolyte salt. Optionally, where needed, a portion of the sodium tetrachloroaluminate powder was combined with nickel chloride salt and sodium chloride, to produce a ternary electrolyte, which was stored in a glove box for use in cell fabrication. The electrolyte may be prepared in a manner discussed herein, or can be directly obtained form Sigma Aldrich.

### Preparation of Electrochemical Cell

The electrochemical cell 100 was assembled as follows. Separator tubes 116, cylindrical or cloverleaf in shape, were produced according to known methods; or were commercially obtained. Each tube 116 was ceramic sodium conductive beta″-alumina. The cylinder dimensions were 228 millimeters length, 36 millimeters, internal diameter, and 38 millimeters, outside diameter. These are dimensions from lobe tip to lobe tip, when a clover leaf shaped separator tube was employed. Each ceramic separator tube was glass sealed to an alpha alumina collar, to form an assembly. Each assembly was placed in a stainless steel housing 112 that served as the housing to form an electrochemical cell. The housing size was about 38 millimeters×38 millimeters×230 millimeters.

The electrode composition granules prepared using the procedure mentioned above, were placed in the β″-alumina tube. The β″-alumina tube was pre-assembled with an anode chamber and a positive electrode current collector, and densified by vibration on a vibratory shaker in a nitrogen filled glove box. The positive electrode was then injected with the molten sodium tetrachloroaluminate NaAlCl₄ (as prepared above), under vacuum at 280 degrees Celsius. Following this, the cell cap was welded at a temperature of about 230 degrees Celsius inside the glove box, using a MaxStar Miller Welder, with ultra-high purity argon purge, and tested for leaks.

### Cell Test Protocol

Cell testing was performed with a 100A, 10V, multi-channel Digatron BTS600 battery testing system. The cell was connected with four cables: positive and negative potential sense and positive and negative current supply. The positive voltage and current cables were connected to the positive tab. The negative voltage and current cables were connected to the negative tab.

All cells were assembled in the discharged state. The testing protocol was as follows:
1. Starting at 80 mA and ramping up to 5.5 A over time, charge to 2.67V, then at 2.67V to a current of 500 mA, while at 330° C.
2. Reduce temperature to 300° C. and discharge at −16 A to 1.8V or 32 Ah.
3. Charge at 10 A to 2.67V, then at 2.67V down to 500 mA.
4. Discharge at −16 A to 1.8V or 32 Ah.
5. Repeat steps 3 and 4 for a total of 10 cycles.
6. Charge at 15 A to 2.67V, then at 2.67V to a current of 500 mA.
7. Discharge at −60 W to 22 Ah or 1.8V.
8. Charge at 15 A to 2.67V, then at 2.67V to a current of 500 mA.
9. Discharge at −120 W to 1.8V.
10. Charge at 15 A to 2.67V, then at 2.67V to a current of 500 mA.
11. Discharge at −130 W to 22 Ah or 1.8V.
12. Charge at 15 A to 2.67V, then at 2.67V to a current of 500 mA.
13. Discharge at −140 W to 22 Ah or 1.8V.
14. Charge at 15 A to 2.67V, then at 2.67V to a current of 500 mA.
15. Discharge at −155 W to 22 Ah or 1.8V.
16. Charge at 15 A to 2.67V, then at 2.67V to a current of 500 mA.
17. Discharge at −110 W to 1.8V or 15 min, then at 1.8V to 15 min.
18. Repeat steps 16 and 17 100 times.
19. Go to step 6 to repeat steps 6-18 once, for a total of 225 cycles.
   Step 1 is the maiden charge, which starts at low current to avoid excessive current densities during the initial production of sodium in the negative electrode. Steps 3 and 4 are mild conditioning cycles before the start of the UPS testing. Step 7 is a low-power cycle to measure cell resistance at deep Depths of Discharge (DoD). Steps 9, 11, 13, and 15 are high-power discharges to test the capability of our cells beyond the 110 W UPS qualification cycles. Steps 16 and 17 are the representative UPS qualification cycles. The protocol ends after only 225 cycles, to maximize cell-testing throughput while still getting enough data to make initial performance comparisons.

### Examples 1, 2, and 3 (E-1, E-2, E-3) and Comparative Example 1 and 2 (CE-1 and CE-2)

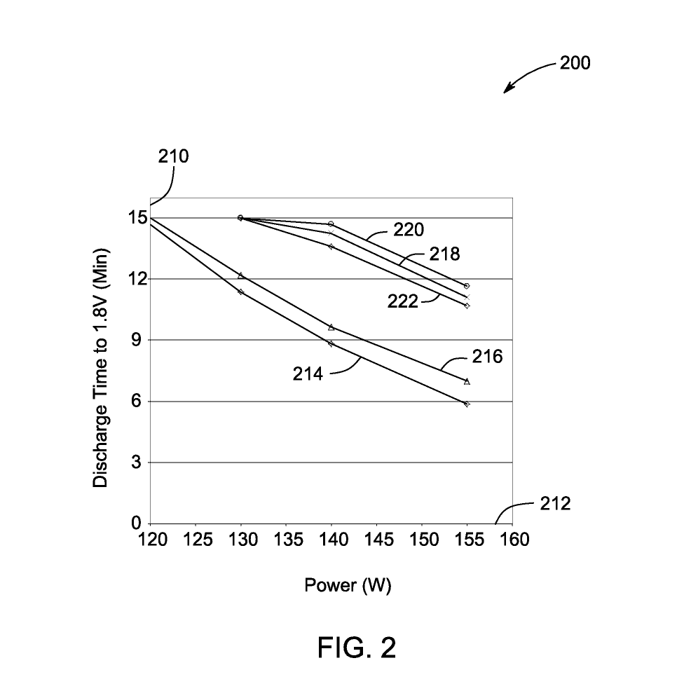

Cells having similar compositions were assembled and tested according to the testing protocol. The positive electrode compositions are given in Table 2, and the cell testing results are provided in FIG. 2. For each composition, three cells were tested using the cell testing protocol.

TABLE 2

| | | | | | | | | Weight percent of NaI with |
|---|---|---|---|---|---|---|---|---|
| Examples | Al | NaI | NaF | NaCl | Fe | Ni | NaAlCl₄ | respect to metal halides |
| CE-1 | 2 | 0 | 0 | 99.01 | 6.89 | 124.18 | 119 | 0.00 |
| CE-2 | 2 | 0 | 5.63 | 94.26 | | 124.18 | 119 | 0.00 |
| E-1 | 2 | 2 | 0 | 97.84 | | 124.18 | 119 | 0.91 |
| E-2 | 2 | 2 | 5.63 | 93.09 | | 124.18 | 119 | 0.91 |
| E-3 | 1 | 1 | 2.18 | 96.85 | | 124.18 | 119 | 0.46 |

Referring to FIG. 2, a graph 200 shows the discharge time of each cell, in accordance with some embodiments of the invention. The results shown in the graph were obtained for an average of about 10 cells, with the positive electrode being made from the compositions of E-1, E-2, E-3, CE-1, and CE-2. The graph includes discharge times at 120 W, 130 W, 140 W and 155 W to 1.8 V, in minutes on the Y-axis 210, versus power on the X-axis 212. Curve 214 and curve 216 represent the results for CE-1 and CE-2 respectively, where 0 percent sodium iodide was employed. Curves 218, 220, and 222 represent E-1, E-2, and E-3 respectively. The results for cells E-1, E-2 and E-3, all of which contain amounts of sodium iodide within the specifications of this invention, are superior to the results for cells CE-1 and CE-2, which contain no sodium iodide. Nor does it appear necessary to include larger amounts of sodium iodide, as has been described elsewhere. Cell E-3 performs at the same level as cells E-1 and E-2, while containing only half as much sodium iodide.

The foregoing examples are illustrative of some features of the invention. The appended claims are intended to claim the invention as broadly as has been conceived; and the examples herein presented are illustrative of selected embodiments from a collection of all possible embodiments. Accordingly, it is Applicants' intention that the appended claims not be construed as limiting the illustrated features of the invention, by the choice of examples utilized. As used in the claims, the word “comprises” and its grammatical variants logically also subtend and include phrases of varying and differing extent. such as for example, but not limited thereto, “consisting essentially of” and “consisting of.” Where necessary, ranges have been supplied, and those ranges are inclusive of all sub-ranges there-between. It is to be expected that variations in these ranges will suggest themselves to a practitioner having ordinary skill in the art and, where not already dedicated to the public, the appended claims should cover those variations. Advances in science and technology may make equivalents and substitutions possible, that are not now contemplated by reason of the imprecision of language. These variations should be covered by the appended claims.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have a utility distinct from the utility of the reaction product or final material. Other subsequent changes, transformations, or reactions may result from bringing the specified reactants and/or components together under the conditions called for pursuant to this disclosure. In these other subsequent changes, transformations, or reactions, the reactants, ingredients, or the components to be brought together may identify or indicate the reaction product.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A positive electrode composition comprising:
at least one electroactive metal selected from the group consisting of nickel, cobalt, iron, zinc, tin, vanadium, niobium, manganese and antimony;
a first alkali metal halide;
an electrolyte comprising a complex metal halide salt having a second alkali metal halide, wherein the first alkali metal halide and the second alkali metal halide independently comprise a halide selected from chlorine, bromine, and fluorine; and
sodium iodide present in an amount in a range from about 0.1 weight percent to about 0.9 weight percent, based on a total weight of metal halides present in the positive electrode composition.

2. The positive electrode composition according to claim 1, wherein the electroactive metal comprises nickel.

3. The positive electrode composition according to claim 1, wherein the electroactive metal is present in a range of from about 11 volume percent to about 19 volume percent, based on a total volume of the positive electrode composition.

4. The positive electrode composition according to claim 1, wherein each of the first alkali metal halide and the second alkali metal halide comprise an alkali metal independently selected from the group consisting of sodium, potassium, and lithium.

5. The positive electrode composition according to claim 1, wherein sodium iodide is present from about 0.3 weight percent to about 0.7 weight percent, based on the total weight of metal halides present in the positive electrode composition.

6. The positive electrode composition according to claim 1, further comprising sulfur in an amount ranging from about 0.1 weight percent to about 25 weight percent, based on a total weight of the positive electrode composition.

7. The positive electrode composition according to claim 6, wherein the amount of sulfur ranges from about 0.1 weight percent to about 3 weight percent, based on a total weight of the positive electrode composition.

8. The positive electrode composition according to claim 6, wherein the amount of sulfur ranges from about 10 weight percent to about 25 weight percent, based on a total weight of the positive electrode composition.

9. The positive electrode composition according to claim 1, further comprising additional aluminum in elemental form in an amount no greater than about 1.5 weight percent, based on a total weight of the positive electrode composition.

10. The positive electrode composition according to claim 1, wherein the electrolyte has a melting temperature in a range from about 150 degrees Celsius to about 300 degrees Celsius.

11. The positive electrode composition according to claim 1, wherein the electrolyte comprises sodium tetrachloroaluminate (NaAlCl₄).

12. An energy storage device, comprising a first compartment comprising an alkali metal, a second compartment comprising a positive electrode composition and a solid separator capable of transporting alkali metal ions between the first compartment and the second compartment, wherein the positive electrode composition itself comprises:
at least one electroactive metal selected from the group consisting of nickel, cobalt, iron, zinc, tin, vanadium, niobium, manganese and antimony;
a first alkali metal halide;
an electrolyte comprising a complex metal halide having a second alkali metal halide, wherein the first alkali metal halide and the second alkali metal halide independently comprise a halide selected from chlorine, bromine, and fluorine; and
sodium iodide present in an amount in a range from about 0.1 weight percent to about 0.9 weight percent, based on a total weight of metal halides present in the positive electrode composition.

13. The energy storage device according to claim 12, wherein the solid separator comprises a beta-alumina, a beta″-alumina, a gamma alumina, a micromolecular sieve, a silicon nitride, or a silicophosphate.

14. The energy storage device according to claim 12, wherein the solid separator comprises a beta″-alumina.

15. The energy storage device according to claim 12, wherein the alkali metal is selected from sodium, potassium and lithium.

16. The energy storage device according to claim 12, wherein the alkali metal is molten sodium.

17. The energy storage device according to claim 12, wherein the device is rechargeable over a plurality of cycles.

18. The energy storage device according to claim 12, is in the form of an uninterruptable power supply device.

19. An energy storage battery comprising a plurality of energy storage devices in accordance with claim 12.
